(19) United States
(12) Patent Application Publication
(10) Pub. No.: US 2026/0010038 A1
(43) Pub. Date: Jan. 8, 2026

(54) OPTICAL COMPENSATION FILM, DISPLAY PANEL, AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Yanping Liao, Beijing (CN); Xibin Shao, Beijing (CN); Dongchuan Chen, Beijing (CN); Jianhua Huang, Beijing (CN); Yingying Qu, Beijing (CN); Lingdan Bo, Beijing (CN); Lujie Nie, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/992,664

(22) PCT Filed: Mar. 13, 2024
(86) PCT No.: PCT/CN2024/081504

§ 371 Date: Jan. 9, 2025

(30) Foreign Application Priority Data
Apr. 21, 2023 (CN) 202310436631.7

(51) Int. Cl. G02F 1/13363; G02F 1/1335

(52) U.S. Cl. CPC G02F 1/13363; G02F 1/133531; G02F 1/13356

(57) ABSTRACT

The present disclosure provides an optical compensation film and a display panel, and relates to the technical field of displays; the optical compensation film is applied to a display panel; wherein the optical compensation film includes a first compensation layer and a second compensation layer, the optical compensation film is arranged between a liquid crystal layer and a polarizer of the display panel, the first compensation layer is located on a side of the second compensation layer away from the liquid crystal layer, the second compensation layer is a +A type compensation layer, and satisfies nz=ny<nx; Rth₁(λ)/Rth₂(λ) is less than 0; wherein nz is the refractive index of the compensation layer in the thickness direction, nx and ny are the refractive indices of the compensation layer in the in-plane direction, and the directions of x and y are orthogonal.

### CROSS-REFERENCE TO RELATED APPLICATION

The present disclosure claims priority to Chinese Patent Application No. 202310436631.7, entitled “OPTICAL COMPENSATION FILM, DISPLAY PANEL, AND DISPLAY DEVICE”, filed on Apr. 21, 2023, to China National Intellectual Property Administration, the entire contents of which are incorporated herein by reference.

### FIELD

The present disclosure relates to the technical field of displays, and in particular to an optical compensation film, a display panel and a display device.

### BACKGROUND

Liquid crystal display (LCD) devices have been the mainstream display apparatuses in the fields of electronic communications, household appliances, aerospace, industrial control, and automotive electronics, etc. over the years of development. Although the performance of liquid crystal display devices has basically met the requirements of people's use, the problem of viewing angle has not been well solved. For example, as the viewing angle increases, the contrast ratio of the image continuously decreases, which subsequently leads to a decline in picture clarity; the decrease in contrast ratio is primarily attributed to the exacerbation of light leakage issues in the dark state that occurs with the increase in viewing angle.

The current improvement scheme can improve the dark state light leakage at a large viewing angle to some extent, but it will bring a color cast at a large viewing angle which still needs to be further improved.

### SUMMARY

The embodiments of the present disclosure adopt the following technical solutions.

In a first aspect, embodiments of the present disclosure provide an optical compensation film, applied to a display panel, wherein the optical compensation film comprises a first compensation layer and a second compensation layer, the optical compensation film is arranged between a liquid crystal layer and a polarizer of the display panel, the first compensation layer is located on a side of the second compensation layer away from the liquid crystal layer, the second compensation layer is a +A type compensation layer, and satisfies nz=ny<nx;
Rth1(λ)/Rth2(λ) is less than 0;
wherein nz is a refractive index of the compensation layer in a thickness direction, nx and ny are refractive indices of the compensation layer in an in-plane direction, and a direction of x is orthogonal to that of y; Rth1(λ) is an optical path difference compensation value of the first compensation layer for a light having a wavelength λ in a thickness direction, and Rth2(λ) is an optical path difference compensation value of the second compensation layer for a light having a wavelength λ a the thickness direction.

In at least one embodiment of the present disclosure, the first compensation layer comprises one of a −B type compensation layer, a +B type compensation layer, a +C type compensation layer, and a −C type compensation layer.

In at least one embodiment of the present disclosure, the first compensation layer is a +C type compensation layer, and nz>nx=ny is satisfied;
an absolute value of R02(λ)/R01(λ) is greater than or equal to 1;
wherein R02 is an optical path difference compensation value of the second compensation layer for a light having a wavelength λ in an in-plane direction, and R01 is an optical path difference compensation value of the first compensation layer for a light having a wavelength λ in an in-plane direction.

In at least one embodiment of the present disclosure, an optical path difference compensation value Rth1 (550 nm) of the first compensation layer for a light having a wavelength of 550 nm in a thickness direction ranges from −150 nm to −50 nm.

In at least one embodiment of the present disclosure, an optical path difference compensation value R01 (550 nm) of the first compensation layer for a light having a wavelength of 550 nm in an in-plane direction ranges from −50 nm to 50 nm.

In at least one embodiment of the present disclosure, the optical path difference compensation value R01 (550 nm) of the first compensation layer for the light having a wavelength of 550 nm in the in-plane direction ranges from −25 nm to 25 nm.

In at least one embodiment of the present disclosure, an optical path difference compensation value Rth2 (550 nm) of the second compensation layer for a light having a wavelength of 550 nm in a thickness direction ranges from 12.5 nm to 112.5 nm.

In at least one embodiment of the present disclosure, an optical path difference compensation value Rth2 (550 nm) of the second compensation layer for a light having a wavelength of 550 nm in a thickness direction ranges from 37.5 nm to 87.5 nm.

In at least one embodiment of the present disclosure, an optical path difference compensation value R02 (550 nm) of the second compensation layer for a light having a wavelength of 550 nm in an in-plane direction ranges from 75 nm to 175 nm.

In at least one embodiment of the present disclosure, materials in the first compensation layer and the second compensation layer are both positive dispersion materials;
alternatively, the materials in the first compensation layer and the second compensation layer are both negative dispersion materials.

In a second aspect, embodiments of the present disclosure provide a display panel, comprising the optical compensation film as described in any one of the first aspect, the display panel further comprising a first polarizer, a liquid crystal layer, and a second polarizer arranged in sequence, wherein the second polarizer is a light-emitting side polarizer; a minimum distance between the second compensation layer and the liquid crystal layer is less than a minimum distance between the first compensation layer and the liquid crystal layer;
wherein the optical compensation film is located between the first polarizer and the liquid crystal layer, or the optical compensation film is located between the second polarizer and the liquid crystal layer.

In at least one embodiment of the present disclosure, under the condition that the optical compensation film is located between the second polarizer and the liquid crystal layer,
a direction of an absorption axis of the first polarizer is consistent with an in-plane orientation direction of liquid crystal molecules in the liquid crystal layer, a direction of an absorption axis of the second polarizer is consistent with a direction of an optical axis of the second compensation layer, and the direction of the optical axis of the second compensation layer is perpendicular to the in-plane orientation direction of the liquid crystal molecules in the liquid crystal layer.

In at least one embodiment of the present disclosure, under the condition that the optical compensation film is located between the first polarizer and the liquid crystal layer,
a direction of an absorption axis of the second polarizer is consistent with the in-plane orientation direction of the liquid crystal molecules in the liquid crystal layer, the direction of the absorption axis of the first polarizer is consistent with the direction of the optical axis of the second compensation layer, and the direction of the optical axis of the second compensation layer is perpendicular to the in-plane orientation direction of the liquid crystal molecules in the liquid crystal layer.

In at least one embodiment of the present disclosure, the in-plane orientation direction of the liquid crystal molecules in the liquid crystal layer is approximately 0° or the in-plane orientation direction of the liquid crystal molecules in the liquid crystal layer is approximately 90°.

In a third aspect, embodiments of the present disclosure provide a display device, comprising a display panel as described in any one of the second aspects.

The above description is only an overview of the technical solution of the present disclosure. In order to better understand the technical means of the present disclosure, it can be implemented in accordance with the contents of the specification, and in order to make the above and other purposes, features and advantages of the present disclosure more clearly understand, the specific implementation of the present disclosure is listed below.

### BRIEF DESCRIPTION OF THE DRAWINGS

FIG. 1 is a schematic view showing an absorption axis direction of two polarizers of a liquid crystal display panel in related art at a positive viewing angle according to an embodiment of the present disclosure;

FIG. 2 is a schematic view showing an absorption axis direction of two polarizers of a liquid crystal display panel in related art at a side viewing angle according to an embodiment of the present disclosure;

FIG. 3 is a schematic view of a Poincare sphere analysis of a color cast problem of a display panel in related art provided by an embodiment of the present disclosure;

FIG. 4 is a schematic curve showing optical path difference compensation values of an optical compensation film of a positive dispersion material according to an embodiment of the present disclosure;

FIG. 5 is a schematic view of a Poincare sphere analysis of an improved color cast problem of a display panel provided by an embodiment of the present disclosure;

FIG. 6 is a schematic curve showing optical path difference compensation values of an optical compensation film of a negative dispersion material according to an embodiment of the present disclosure; and

FIG. 7 to FIG. 10 are schematic views of structures of four display panels provided with optical compensation films according to embodiments of the present disclosure.

### DETAILED DESCRIPTION

In the following, the technical solution in the embodiment of the present disclosure will be clearly and completely described with reference to the drawings in the embodiments of the present disclosure. Apparently, the described embodiments are only a part of the embodiments of the present disclosure, but not the whole embodiment. Based on the embodiments in the present disclosure, all other embodiments obtained by persons skilled in the art without expenditure of creative labor belong to the protection scope of the present disclosure.

In the drawings, the thickness of regions and layers may be exaggerated for clarity. In the drawings, the same reference numerals denote the same or similar structures, and therefore their detailed description will be omitted. In addition, the drawings are only schematic illustrations of the present disclosure and are not necessarily drawn to scale.

In the embodiment of the present disclosure, the words “first”, “second”, “third” and “fourth” are used to distinguish the same or similar items with basically the same function and effect, only to clearly describe the technical solution of the embodiments of the present disclosure, and cannot be understood as indicating or implying relative importance or implicitly indicating the number of indicated technical features.

In the embodiments of the present disclosure, the azimuth or positional relationship indicated by the terms “upper” and “lower” is based on the azimuth or positional relationship shown in the appended drawings, which is only for the convenience of describing the present disclosure and simplifying the description, and does not indicate or imply that the devices or elements referred to must have a specific orientation, be constructed and operated in a specific orientation, so it cannot be understood as a limitation of the present disclosure.

In the description of the specification, the terms “one embodiment”, “some embodiments”, “exemplary embodiments”, “examples”, “specific examples” or “some examples” are intended to indicate that a specific feature, structure, material or characteristic related to this embodiment or example is included in at least one embodiment or example of the present disclosure. The schematic representations of the above terms do not necessarily refer to the same embodiment or example. Furthermore, the described specific features, structures, materials or characteristics may be included in any one or more embodiments or examples in any suitable way.

In the embodiment of the present disclosure, the meaning of “multiple” is two or more, and the meaning of “at least one” is one or more, unless otherwise specifically defined.

The features such as “parallel”, “vertical” and “identical” used in the embodiment of the present disclosure all include the features such as “parallel”, “vertical” and “identical” in the strict sense, and the cases such as “approximately parallel”, “approximately vertical” and “approximately identical” contain certain tolerances, taking into account the measurement and the tolerances related to the measurement of a specific quantity (for example, the limitations of the measurement system). For example, “approximately” can mean within one or more standard deviations, or within 3% or 5% of the stated value.

Unless the context requires otherwise, throughout the specification and claims, the term “including” is interpreted as an open and inclusive meaning, that is, “including but not limited to”.

The polygons in this specification are not critical and may be approximated as triangles, parallelograms, trapezoids, pentagons, or hexagons, etc. and there may be some small deformations caused by tolerances.

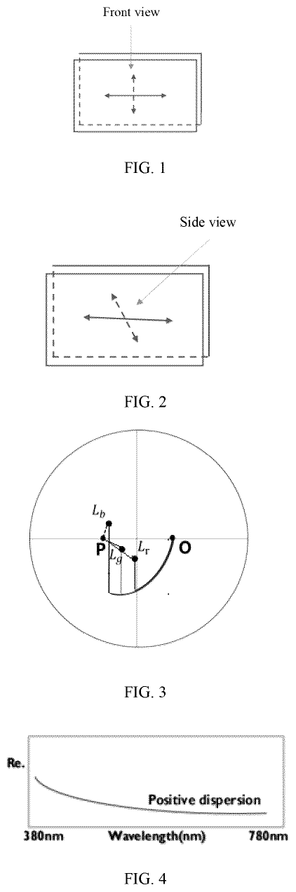

With the development of display technology and the upgrading of product specifications, the dark state light leakage problem of liquid crystal display panels has become a critical problem in the development of liquid crystal display. For example, for a liquid crystal display panel of ADS (Advanced Super Dimension Switch) type or the like, the main reason for light leakage at a large viewing angle (oblique viewing angle) is that the absorption axes of the upper polarizer and the lower polarizer are not orthogonal; as shown in FIG. 1, in a positive viewing angle state, the absorption axes of the upper polarizer and the lower polarizer in the liquid crystal display panel are orthogonal, and thus, when the liquid crystal display panel is in a dark state, light rays in a positive viewing angle direction cannot pass through two polarizers with orthogonal absorption axes at the same time, and light does not leak in the dark state under the positive viewing angle; as shown in FIG. 2, the absorption axes of the upper polarizer and the lower polarizer in the liquid crystal display panel are not orthogonal in the state of a large viewing angle (squint or side view), thus, in the case that the liquid crystal display panel is in the dark state, some light leaks from the direction of the large viewing angle, resulting in the problem of light leakage at the large viewing angle in the dark state.

Due to the different wavelengths of lights of different colors, and the different phase differences of light, the optical film layer in the related art often brings about a problem of color cast at a large viewing angle when improving the light leakage at a large viewing angle, such as, the problem of redness at a large viewing angle or blueness at a large viewing angle.

Based on this, the embodiments of the present disclosure provide an optical compensation film applied to a display panel, applied to a display panel, wherein the optical compensation film comprises a first compensation layer and a second compensation layer, the optical compensation film is arranged between a liquid crystal layer and a polarizer of the display panel, the first compensation layer is located on a side of the second compensation layer away from the liquid crystal layer, the second compensation layer is a +A type compensation layer, and satisfies nz=ny<nx; Rth₁(λ)/Rth₂(λ) is less than 0; wherein nz is a refractive index of the compensation layer in a thickness direction, nx and ny are refractive indices of the compensation layer in an in-plane direction, and a direction of x is orthogonal to that of y; Rth₁(λ) is an optical path difference compensation value of the first compensation layer for a light having a wavelength λ in a thickness direction, and Rth₂(λ) is an optical path difference compensation value of the second compensation layer for a light having a wavelength λ a the thickness direction. The inventors have found that an optical compensation film obtained by combining two different types of compensation layers, in particular, by combining a +A type compensation layer and other types of compensation layers, when the obtained combined optical compensation film is applied to a display panel, such as, applied to an ADS type liquid crystal display panel or an IPS (In-Plane Switching) type liquid crystal display panel, the viewing angle of the display panel can be enlarged, the light leakage phenomenon can be improved, the contrast ratio and picture clarity can be greatly improved, the color cast problem at a large viewing angle can be improved, thereby improving the picture quality of the display panel and the display effect to a great extent. It should be noted that when the optical compensation film is applied to a display panel, the first compensation layer and the second compensation layer in the optical compensation film are always arranged together, the optical compensation film is arranged as a whole in the display panel, and the first compensation layer and the second compensation layer are not arranged separately.

Hereinafter, an optical compensation film and a display panel will be described in detail with reference to the appended drawings provided in the embodiments of the present disclosure.

An embodiment of the present disclosure provides an optical compensation film, which is applied to a display panel; the optical compensation film includes a first compensation layer and a second compensation layer; the optical compensation film is arranged between a liquid crystal layer and a polarizer of the display panel; the first compensation layer is located on a side of the second compensation layer away from the liquid crystal layer; the second compensation layer is a +A type compensation layer, and nz=ny<nx is satisfied;
Rth₁(λ)/Rth₂(λ) is less than 0;
wherein nz is a refractive index of the compensation layer in a thickness direction, nx and ny are the refractive indices of the compensation layer in an in-plane direction, and a direction of x is orthogonal to that of y; Rth₁(λ) is an optical path difference compensation value of the first compensation layer for a light having a wavelength λ in a thickness direction, and Rth₂(λ) is an optical path difference compensation value of the second compensation layer for a light having a wavelength λ in a thickness direction.

Here, the types of liquid crystal display panels to which the above optical compensation film is applied are as follows:
for example, the display panel may be a liquid crystal display panel of an IPS (In-Plane Switching) type, an ADS (Advanced Super Dimension Switch) type, or the like.

In an exemplary embodiment, the second compensation layer in the optical compensation film is a +A type compensation layer, and the second compensation layer is arranged adjacent to the liquid crystal layer, and the first compensation layer of the optical compensation film is arranged away from the liquid crystal layer and adjacent to the polarizer.

Wherein the +A type compensation layer satisfies nz=ny<nx;
in an exemplary embodiment, Rth1(λ)is greater than 0 and Rth2(λ)is less than 0; or Rth1(λ) is less than 0 and Rth2(λ) is greater than 0;
in an exemplary embodiment, the wavelength λ in Rth₁(λ)/Rth₂(λ) may range from 480 nm to 580 nm, for example, the wavelength λ may range from 550 nm +25 nm, in particular, the wavelength λ may range from 525 nm, 530 nm, 535 nm, 540 nm, 545 nm, 550nm, 555 nm, 560 nm, 565 nm, 570 nm, 575 nm.

Illustratively, Rth₁ (525 nm)/Rth₂ (525 nm) is less than 0, Rth₁ (530 nm)/Rth₂ (530 nm) is less than 0, Rth₁ (535 nm)/Rth₂ (535 nm) is less than 0, Rth₁ (540 nm)/Rth₂ (540 nm) is less than 0, Rth₁ (545 nm)/Rth₂ (545 nm) is less than 0, Rth₁ (550 nm)/Rth₂ (550 nm) is less than 0, Rth₁ (555 nm)/Rth₂ (555 nm) is less than 0, Rth₁ (560 nm)/Rth₂ (560 nm) is less than 0.

In at least one embodiment of the present disclosure, the first compensation layer includes one of a −B type compensation layer, a +B type compensation layer, a +C type compensation layer, and a −C type compensation layer.

The −B type compensation layer satisfies nz>nx>ny, the +B type compensation layer satisfies nz<ny<nx, the +C type compensation layer satisfies nz>nx=ny, and the −C type compensation layer satisfies nz<nx=ny, wherein nx and ny are refractive indices of the corresponding compensation layer in an in-plane direction, x and y directions are orthogonal to each other, and nz is a refractive index of the corresponding compensation film in a thickness direction.

Illustratively, since the second compensation layer is provided as a +A type compensation layer, the case where Rth₁(λ)/Rth₂(λ) is less than 0 includes, but is not limited to, the following cases:
first, Rth_{-B}(λ)/Rth_{+A}(λ) is less than 0;
for example, one of Rth_{-B}(λ) and Rth_{+A}(λ) is less than 0;
second, Rth_{+B}(λ)/Rth_{+A}(λ) is less than 0;
for example, one of Rth_{+B}(λ) and Rth_{+A}(λ) is less than 0;
third, Rth_{-C}(λ)/Rth_{+A}(λ) is less than 0;
for example, one of Rth_{-C}(80 ) and Rth_{+A}(λ) Rth_{+A}(λ) is less than 0;
fourth, Rth_{+C}(λ)/Rth_{A}(λ) is less than 0;
for example, one of Rth_{+C}(λ) and Rth_{+A}(λ) is less than 0;
wherein Rth_{-B}(λ) is an optical path difference compensation value of the −B type compensation layer for a light with a wavelength λ in the thickness direction, Rth_{+A}(λ) is an optical path difference compensation value of the +A type compensation layer for a light with a wavelength λ in the thickness direction, Rth_{+B}(λ) is an optical path difference compensation value of the +B type compensation layer for a light with a wavelength λ in the thickness direction, Rth_{+C}(λ) is an optical path difference compensation value of the +C type compensation layer for a light with a wavelength λ in the thickness direction, and Rth_{-C}(λ) is an optical path difference compensation value of the −C type compensation layer for a light with a wavelength λ in the thickness direction.

In the optical compensation films provided in the embodiments of the present disclosure, an optical compensation film obtained by combining two different types of compensation layers is used, in particular, a +A type compensation layer and other types of compensation layers are used in combination; and when the obtained combined optical compensation film is applied to a display panel, for example, to an ADS type liquid crystal display panel or an IPS (In-Plane Switching) type liquid crystal display panel, the viewing angle of the display panel can be enlarged, the light leakage phenomenon can be improved, and the contrast ratio and picture clarity can be greatly improved, the color cast at large viewing angle can be greatly improved, thereby improving the picture quality of the display panel and the display effect to a great extent.

In at least one embodiment of the present disclosure, the first compensation layer is a +C type compensation layer and satisfies nz>nx=ny;
at this time, the optical compensation film includes a +C type compensation layer and a +A type compensation layer which are arranged in a stack, wherein the +A type compensation layer is arranged close to the liquid crystal layer, and the +C type compensation layer is arranged close to a polarizer;
wherein an absolute value of R0₂(λ)/R0₁(λ) is greater than or equal to 1;

R0₂ is an optical path difference compensation value of the second compensation layer for a light having a wavelength λ in an in-plane direction, and R0₁ is an optical path difference compensation value of the first compensation layer for a light having a wavelength λ in the in-plane direction.

In an exemplary embodiment, the wavelength λ in R0₂(λ)/R0₁(λ) may range from 480 nm to 580 nm, for example, the wavelength 2 may range from 550 nm +25 nm, in particular, the wavelength λ may range from 525 nm, 530 nm, 535 nm, 540 nm, 545 nm, 550 nm, 555 nm, 560 nm, 565 nm, 570 nm, 575 nm.

Illustratively, the absolute value of R0₂(525 nm)/R0₁(525 nm) is greater than or equal to 1, the absolute value of R0₂(530 nm)/R0₁(530 nm) is greater than or equal to 1, the absolute value of R0₂(535 nm)/R0₁(535 nm) is greater than or equal to 1, the absolute value of R0₂(540 nm)/R0₁(540 nm) is greater than or equal to 1, the absolute value of R0₂(545 nm)/R0₁(545 nm) is greater than or equal to 1, the absolute value of R0₂(550 nm)/R0₁(550 nm) is greater than or equal to 1, the absolute value of R0₂(555 nm)/R0₁(555 nm) is greater than or equal to 1, or the absolute value of R0₂(560 nm)/R0₂R0₁(560 nm) is greater than or equal to 1.

R0=(nx−ny)×d; Rth={(1/2)*(nx+ny)−nz}*d, nz is a refractive index of the compensation layer in a thickness direction, nx and ny are refractive indices of the compensation layer in a in-plane direction, directions of x and y are orthogonal, and d is a thickness of the corresponding compensation layer;
taking a +A type compensation layer as an example, an optical axis direction of the +A type compensation layer is a x-axis direction, a refractive index is nx₍₊ₐ₎, a direction perpendicular to the optical axis in a plane is a y-axis, a refractive index is ny₍₊ₐ₎, a direction perpendicular to a xy-plane is a z-axis, a refractive index is nz₍₊ₐ₎, and a thickness of the +A type compensation layer is d₊ₐ, then

$$R 0 = ( {nx}_{( + a )} - {ny}_{( + a )} ) \times {d}_{+ a} ;$$

$$Rth = \{ ( 1 / 2 ) * ( {nx}_{( + a )} + {ny}_{( + a )} ) - {nz}_{( + a )} \} * {d}_{+ a} .$$

In the following, taking the optical compensation film including a first compensation layer and a second compensation layer, wherein the first compensation layer is a +C type compensation layer and the second compensation layer is a +A type compensation layer as an example, a combination of the +A type compensation layer and the +C type compensation layer is described, and when an obtained combined optical compensation film is applied to a display panel, Ro and Rth under the best display effect are described in detail:
in at least one embodiment of the present disclosure, the optical path difference compensation value Rth₁ (550 nm) of the first compensation layer for a light having a wavelength of 550 nm in the thickness direction ranges from −150 nm to −50 nm.

Illustratively, the first compensation layer is a +C type compensation layer, and Rth_{+C} (550 nm) ranges from −150 nm to 50 nm;
for example, Rth_{+C} (550 nm) may be −145 nm, −140 nm, −135 nm, −130 nm, −125 nm, −120 nm, −115 nm, −110 nm, −105 nm, −100 nm, −95 nm, −90 nm, −85 nm, −80 nm, −70 nm, −60 nm, −50 nm.

In at least one embodiment of the present disclosure, the optical path difference compensation value R0₁ (550 nm) of the first compensation layer for a light having a wavelength of 550 nm in the in-plane direction ranges from −50 nm to 50 nm.

Illustratively, the first compensation layer is a +C type compensation layer, and R0_{+C} (550 nm) ranges from −50 nm to 50 nm;
for example, R0_{+C} (550 nm) may be −45 nm, −40 nm, −35 nm, −30 nm, −25 nm, −20 nm, −15 nm, −10 nm, −5 nm, 0 nm, 5 nm, 10 nm, 15 nm, 20 nm, 25 nm, 30 nm, 35 nm, 40 nm, 45 nm.

In at least one embodiment of the present disclosure, the optical path difference compensation value R0₁ (550 nm) of the first compensation layer for light having a wavelength of 550 nm in the in-plane direction ranges from −25 nm to 25 nm.

Illustratively, the first compensation layer is a +C type compensation layer, and R_{+C} (550 nm) ranges from −25 nm to 25 nm;

For example, R0_{+C} (550 nm) may be −20 nm, −15 nm, −10 nm, −5 nm, 0 nm, 5 nm, 10 nm, 15 nm, 20 nm.

In at least one embodiment of the present disclosure, the optical path difference compensation value Rth₂ (550 nm) of the second compensation layer for a light having a wavelength of 550 nm in the thickness direction ranges from 12.5 nm to 112.5 nm.

In at least one embodiment of the present disclosure, the optical path difference compensation value Rth₂ (550 nm) of the second compensation layer for a light having a wavelength of 550 nm in the thickness direction ranges from 37.5 nm to 87.5 nm.

Illustratively, an optical path difference compensation value Rth₂ (550 nm) of the second compensation layer for a light having a wavelength of 550 nm in the thickness direction may be 62.5+25 nm;
for example, Rth₂ (550 nm) may be 38 nm, 40 nm, 42 nm, 45 nm, 48 nm, 50 nm, 55 nm, 58 nm, 60 nm, 65 nm, 70 nm, 75 nm, 80 nm, 85 nm.

In at least one embodiment of the present disclosure, the optical path difference compensation value R0₂ (550 nm) of the second compensation layer for a light having a wavelength of 550 nm in the in-plane direction ranges from 75 nm to 175 nm.

Illustratively, an optical path difference compensation value R0₂ (550 nm) of the second compensation layer for a light having a wavelength of 550 nm in an in-plane direction ranges from 125 nm+25 nm;
for example, R0₂ (550 nm) may be 100 nm, 105 nm, 110 nm, 115 nm, 120 nm, 125 nm, 130 nm, 135 nm, 140 nm, 145 nm, 150 nm.

In at least one embodiment of the present disclosure, the materials in the first compensation layer and the second compensation layer are both positive dispersion materials;
alternatively, the materials in the first compensation layer and the second compensation layer are both negative dispersion materials.

Preferably, the materials in the first compensation layer and the second compensation layer are both negative dispersion materials.

Illustratively, as shown in FIG. 4, the absolute value of the optical path difference of the optical compensation film of the positive dispersion materials decreases as the wavelength increases and becomes stable in a region of high wavelength. As shown in FIG. 6, the absolute value of the optical path difference of the optical compensation film of the negative dispersion materials increases as the wavelength increases; wherein, in FIG. 4 and FIG. 6, an abscissa is a wavelength (Wavelength) and an ordinate is an absolute value of an optical path difference (Re.), and the absolute value of the optical path difference (Re.) may include Rth or R0.

Illustratively, both the positive dispersion materials and the negative dispersion materials may include polymeric light transmissive materials, such as polyesters, polycarbonates, polymethyl methacrylates, polyethylene terephthalate, and the like.

Illustratively, a light transmittance of the polymeric light transmitting material may be greater than or equal to 85%, for example, the light transmittance is greater than or equal to 90%;
illustratively, a water absorption of the polymeric light transmitting material may be less than 0.8%.

As shown in FIG. 3, a point O (a starting point) represents a polarization angle transmitted through a lower polarizer (also referred to as a first polarizer) in a direction of a large viewing angle, and a point P (an ending point) represents an absorption axis angle of an upper polarizer (also referred to as a second polarizer, which is a light-emitting side polarizer). When viewing at a positive viewing angle, since a direction of a transmission axis of the lower polarizer is consistent with that of an absorption axis of the upper polarizer, the point P and the point O coincide, the light transmitted through the lower polarizer is absorbed by the upper polarizer, and there is no light leakage at the positive viewing angle. In a large viewing angle direction, since the directions of the absorption axises of the upper and lower polarizers are not perpendicular, that is, the direction of the transmission axis of the lower polarizer is not consistent with that of the absorption axis of the upper polarizer, as shown in FIG. 3, the point P and the point O are separated. A purpose of a large viewing angle compensation is to change a polarized light in a point O state into a polarized light in a point P state to make the light transmitted through the lower polarizer in the large viewing angle direction absorbed by the upper polarizer so that no light leakage occurs. The optical film layer in the related art, after performing compensation, makes the distances between end points of a red light, a green light, and a blue light after optical compensation and the point P are Lr, Lg, and Lb respectively, and it can be seen from the figure that since the distance Lr from the end point of the red light after optical compensation to the point P is the maximum, the distance Lb from the end point of the blue light after optical compensation to the point P is the minimum, thus finally a display effect presenting in the display panel is a color cast at a large viewing angle, such as redness at a large viewing angle.

Since a phase difference in an in-plane direction is Δφ=2π×R0/λ and a phase difference in a thickness direction is Δφ=2π×Rth/λ, the absolute values of optical path differences R0 and Rth of the optical compensation film of positive dispersion materials decrease with the increase of wavelength and finally become stable; the absolute values of R0 and Rth of the optical compensation film of negative dispersion materials increase with increase of wavelength.

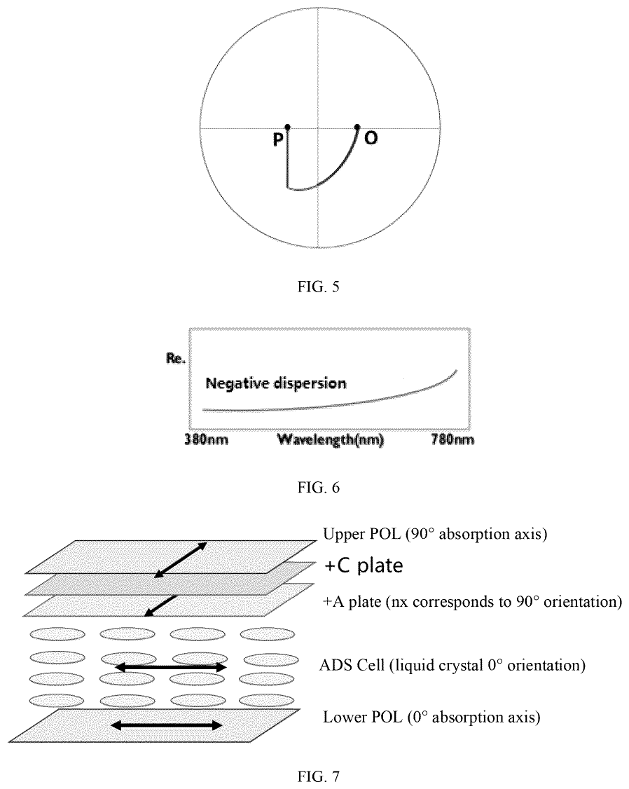

When the optical compensation film provided in the embodiments of the present disclosure is used, for example, the optical compensation film of a negative dispersion material is used, taking the first compensation layer being a +C type compensation layer, the second compensation layer being a +A type compensation layer as a example, and when the +A type compensation layer is arranged close to the liquid crystal layer, the light leakage at a large viewing angle and the color cast at a large viewing angle of the display panel are both greatly improved. As shown in FIG. 5, in a direction of a large viewing angle, since the directions of absorption axises of the upper and lower polarizers are not perpendicular, that is, the direction of a transmission axis of the lower polarizer is not consistent with the direction of an absorption axis of the upper polarizer, as shown in FIG. 3, the point P and the point O are separated. The purpose of the large viewing angle compensation is to change the polarized light in the point O state into the polarized light in the point P state to make the light transmitted through the lower polarizer in the large viewing angle direction absorbed by the upper polarizer so that no light leakage occurs. Since the phase difference in an in-plane direction is Δφ=2π×R0/λ and the phase difference in a thickness direction is Δφ=2π×Rth/λ, the absolute value of the negative dispersion materials R0/Rth increases with the increase of wavelength. Therefore, for different wavelengths of lights (e.g. the red light, the green light, and the blue light), the phase difference Ap generated is equivalent, and the different wavelengths of light can be compensated to an optimal state at the same time so that in the case of solving the problem of light leakage, the color cast at a large viewing angle is improved, the display effect of a display panel is improved, and the picture quality is improved.

The display panel mentioned above may be an ADS (Advanced Super Dimension Switch) type liquid crystal display panel or an IPS (In-Plane Switching) type liquid crystal display panel.

An embodiment of the present disclosure provides a display panel, including the optical compensation film as stated above, and the display panel further includes a first polarizer, a liquid crystal layer, and a second polarizer arranged in sequence, wherein the second polarizer is a light-emitting side polarizer; a minimum distance between the second compensation layer and the liquid crystal layer is less than a minimum distance between the first compensation layer and the liquid crystal layer; wherein the optical compensation film is located between the first polarizer and the liquid crystal layer, or the optical compensation film is located between the second polarizer and the liquid crystal layer.

The minimum distance between the second compensation layer and the liquid crystal layer is less than the minimum distance between the first compensation layer and the liquid crystal layer means that in the thickness direction of the display panel, the distance between the second compensation layer and the liquid crystal layer is less than the distance between the first compensation layer and the liquid crystal layer, that is, the second compensation layer is arranged close to one side of the liquid crystal layer, and the first compensation layer is arranged away from the liquid crystal layer and close to one side of the polarizer.

In the display panel provided in the embodiments of the present disclosure, since an optical compensation film is arranged between the liquid crystal layer and the polarizer of the display panel, and the optical compensation film includes a first compensation layer and a second compensation layer, the second compensation layer is a +A type compensation layer, and nz=ny<nx is satisfied, and Rth₁(λ)/Rth₂(λ) is less than 0; wherein nz is a refractive index of the compensation layer in a thickness direction, nx and ny are refractive indices of the compensation layer in an in-plane direction, and a direction of x is orthogonal to that of y; Rth₁(λ) is an optical path difference compensation value of the first compensation layer for a light having a wavelength λ in a thickness direction, and Rth₂(λ) is an optical path difference compensation value of the second compensation layer for a light having a wavelength λ a the thickness direction. In this way, the viewing angle of the display panel can be enlarged, the light leakage phenomenon can be improved, the contrast ratio and picture clarity can be greatly improved, the color cast problem at a large viewing angle can be improved, thereby improving the picture quality of the display panel and the display effect to a great extent.

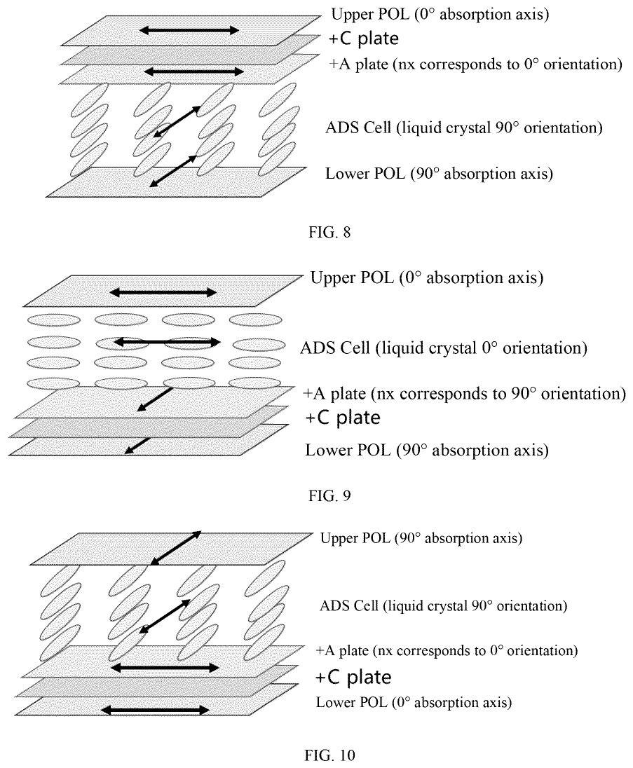

In at least one embodiment of the present disclosure, illustratively, as shown in FIG. 7 and FIG. 8, in the case that the optical compensation is located between the second polarizer (e.g. an upper POL) and the liquid crystal layer, the direction of the absorption axis of the first polarizer (e.g. a lower POL) is consistent with the in-plane orientation direction of the liquid crystal molecules in the liquid crystal layer, the direction of the absorption axis of the second polarizer is consistent with the direction of the optical axis of the second compensation layer (a +A type compensation layer), and the direction of the optical axis of the second compensation layer (a +A type compensation layer) is perpendicular to the in-plane orientation direction of the liquid crystal molecules in the liquid crystal layer.

Illustratively, in FIG. 7, the in-plane orientation direction of the liquid crystal molecules in the liquid crystal layer is approximately 0°, and the direction of the absorption axis of the first polarizer (e.g. the lower POL) is consistent with the in-plane orientation direction of the liquid crystal molecules in the liquid crystal layer, that is, the direction of the absorption axis of the first polarizer is approximately 0°; the direction of the absorption axis of the second polarizer is consistent with the direction of the optical axis of the second compensation layer (the +A type compensation layer), the direction of the optical axis of the second compensation layer (the +A type compensation layer) is approximately 90°.

It should be noted that in the embodiments of the present disclosure, “approximately” means to be within an acceptable range of deviation for a particular value as determined by persons skilled in the art. For example, “approximately” can mean within one or more standard deviations. In this case, approximately 0° may be understood as 0°±3°, such as −1°, −1°, −3°, 0°, 1°, 2°, 3°.

Approximately 90° may be understood as 90°±3°, such as 87°, 88°, 89°, 90°, 91°, 92° and 93°.

Illustratively, in FIG. 8, the in-plane orientation direction of the liquid crystal molecules in the liquid crystal layer is approximately 90°, and the direction of the absorption axis of the first polarizer (e.g. the lower POL) is consistent with the in-plane orientation direction of the liquid crystal molecules in the liquid crystal layer, that is, the direction of the absorption axis of the first polarizer is approximately 90°; the direction of the absorption axis of the second polarizer is consistent with the direction of the optical axis of the second compensation layer (the +A type compensation layer), the direction of the optical axis of the second compensation layer (the +A type compensation layer) is approximately 0°.

In at least one embodiment of the present disclosure, illustratively, as shown in FIG. 9 and FIG. 10, in the case that the optical compensation film is located between the first polarizer (e.g. a lower POL) and the liquid crystal layer, the direction of the absorption axis of the second polarizer (e.g. an upper POL) is consistent with the in-plane orientation direction of the liquid crystal molecules in the liquid crystal layer, the direction of the absorption axis of the first polarizer (e.g. the lower POL) is consistent with the direction of the optical axis of the second compensation layer (the +A type compensation layer), and the direction of the optical axis of the second compensation layer (the +A type compensation layer) is perpendicular to the in-plane orientation direction of the liquid crystal molecules in the liquid crystal layer.

Illustratively, as shown in FIG. 9, the in-plane orientation direction of the liquid crystal molecules in the liquid crystal layer is approximately 0°, the direction of the absorption axis of the second polarizer (e.g. the upper POL) is consistent with the in-plane orientation direction of the liquid crystal molecules in the liquid crystal layer, the direction of the absorption axis of the first polarizer (e.g. the lower POL) is consistent with the direction of the optical axis of the second compensation layer (the +A type compensation layer), and the direction of the optical axis of the second compensation layer (the +A type compensation layer) is approximately 90°.

Illustratively, as shown in FIG. 10, the in-plane orientation direction of the liquid crystal molecules in the liquid crystal layer is approximately 90°, the direction of the absorption axis of the second polarizer (e.g. the upper POL) is consistent with the in-plane orientation direction of the liquid crystal molecules in the liquid crystal layer, the direction of the absorption axis of the first polarizer (e.g. the lower POL) is consistent with the direction of the optical axis of the second compensation layer (the +A type compensation layer), and the direction of the optical axis of the second compensation layer (the +A type compensation layer) is approximately 0°.

In at least one embodiment of the present disclosure, the in-plane orientation direction of the liquid crystal molecules in the liquid crystal layer is approximately 0° or the in-plane orientation direction of the liquid crystal molecules in the liquid crystal layer is approximately 90°.

“Approximately” can mean within one or more standard deviations. In this case, approximately 0° may be understood as 0°±3° such as −1°, −1°, −3°, 0°, 1°, 2°, and 3°.

Approximately 90° may be understood as 90°±3°, such as 87°, 88°, 89°, 90°, 91°, 92° and 93°.

Embodiments of the present disclosure provide a display device including a display panel as described in any of the preceding paragraphs.

The display device may be any product or component having a display function, such as a television, a digital camera, a cell phone, a tablet computer, etc. The display device may be an LCD display device, for example, a liquid crystal display device such as an IPS (In-Plane Switching) type or an ADS (Advanced Super Dimension Switch) type and the like.

In the display device, since an optical compensation film is arranged between the liquid crystal layer and the polarizer of the display panel, and the optical compensation film includes a first compensation layer and a second compensation layer, the second compensation layer is a +A type compensation layer, and nz=ny<nx is satisfied, and Rth₁(λ)/Rth₂(λ) is less than 0; wherein nz is a refractive index of the compensation layer in a thickness direction, nx and ny are refractive indices of the compensation layer in an in-plane direction, and a direction of x is orthogonal to that of y; Rth₁(λ) is an optical path difference compensation value of the first compensation layer for a light having a wavelength λ in a thickness direction, and Rth₂(λ) is an optical path difference compensation value of the second compensation layer for a light having a wavelength λ a the thickness direction. In this way, the viewing angle of the display panel can be enlarged, the light leakage phenomenon can be improved, the contrast ratio and picture clarity can be greatly improved, the color cast problem at a large viewing angle can be improved, thereby improving the picture quality of the display panel and the display effect to a great extent.

The above is only the specific implementation of the present disclosure, but the protection scope of the present disclosure is not limited to this. Any person skilled in the art can easily think of changes or substitutions within the technical scope disclosed in the present disclosure, which should be covered by the present disclosure. Therefore, the protection scope of the present disclosure should be based on the protection scope of the claims.

1. An optical compensation film, applied to a display panel, wherein the optical compensation film comprises a first compensation layer and a second compensation layer, the optical compensation film is arranged between a liquid crystal layer and a polarizer of the display panel, the first compensation layer is located on a side of the second compensation layer away from the liquid crystal layer, the second compensation layer is a +A type compensation layer, and satisfies nz=ny<nx;
Rth₁(λ)/Rth₂(λ) is less than 0;
wherein nz is a refractive index of the compensation layer in a thickness direction, nx and ny are refractive indices of the compensation layer in an in-plane direction, and a direction of x is orthogonal to that of y; Rth₁(λ) is an optical path difference compensation value of the first compensation layer for a light having a wavelength λ in a thickness direction, and Rth₂(λ) is an optical path difference compensation value of the second compensation layer for a light having a wavelength λ in a thickness direction.

2. The optical compensation film according to claim 1, wherein the first compensation layer comprises one of a −B type compensation layer, a +B type compensation layer, a +C type compensation layer, and a −C type compensation layer.

3. The optical compensation film according to claim 1, wherein the first compensation layer is a +C type compensation layer, and nz>nx=ny is satisfied;
an absolute value of R0₂(λ)/R0₁(λ) is greater than or equal to 1;
wherein R0₂ is an optical path difference compensation value of the second compensation layer for a light having a wavelength λ in an in-plane direction, and R0₁ is an optical path difference compensation value of the first compensation layer for a light having a wavelength λ in an in-plane direction.

4. The optical compensation film according to claim 3, wherein an optical path difference compensation value Rth₁(550 nm) of the first compensation layer for a light having a wavelength of 550 nm in a thickness direction ranges from −150 nm to −50 nm.

5. The optical compensation film according to claim 3, wherein an optical path difference compensation value R0₁ (550 nm) of the first compensation layer for a light having a wavelength of 550 nm in an in-plane direction ranges from −50 nm to 50 nm.

6. The optical compensation film according to claim 5, wherein the optical path difference compensation value R0₁ (550 nm) of the first compensation layer for the light having a wavelength of 550 nm in the in-plane direction ranges from −25 nm to 25 nm.

7. The optical compensation film according to claim 3, wherein an optical path difference compensation value Rth₂ (550 nm) of the second compensation layer for a light having a wavelength of 550 nm in a thickness direction ranges from 12.5 nm to 112.5 nm.

8. The optical compensation film according to claim 3, wherein an optical path difference compensation value Rth₂ (550 nm) of the second compensation layer for a light having a wavelength of 550 nm in a thickness direction ranges from 37.5 nm to 87.5 nm.

9. The optical compensation film according to claim 3, wherein an optical path difference compensation value R0₂ (550 nm) of the second compensation layer for a light having a wavelength of 550 nm in an in-plane direction ranges from 75 nm to 175 nm.

10. The optical compensation film according to claim 1, wherein materials in the first compensation layer and the second compensation layer are both positive dispersion materials;
alternatively, the materials in the first compensation layer and the second compensation layer are both negative dispersion materials.

11. A display panel, comprising the optical compensation film according to claim 1, the display panel further comprising a first polarizer, a liquid crystal layer, and a second polarizer arranged in sequence, wherein the second polarizer is a light-emitting side polarizer; a minimum distance between the second compensation layer and the liquid crystal layer is less than a minimum distance between the first compensation layer and the liquid crystal layer;
wherein the optical compensation film is located between the first polarizer and the liquid crystal layer, or the optical compensation film is located between the second polarizer and the liquid crystal layer.

12. The display panel according to claim 11, wherein under the condition that the optical compensation film is located between the second polarizer and the liquid crystal layer,
a direction of an absorption axis of the first polarizer is consistent with an in-plane orientation direction of liquid crystal molecules in the liquid crystal layer, a direction of an absorption axis of the second polarizer is consistent with a direction of an optical axis of the second compensation layer, and the direction of the optical axis of the second compensation layer is perpendicular to the in-plane orientation direction of the liquid crystal molecules in the liquid crystal layer.

13. The display panel according to claim 11, wherein under the condition that the optical compensation film is located between the first polarizer and the liquid crystal layer,
a direction of an absorption axis of the second polarizer is consistent with the in-plane orientation direction of the liquid crystal molecules in the liquid crystal layer, the direction of the absorption axis of the first polarizer is consistent with the direction of the optical axis of the second compensation layer, and the direction of the optical axis of the second compensation layer is perpendicular to the in-plane orientation direction of the liquid crystal molecules in the liquid crystal layer.

14. The display panel according to claim 12, wherein
the in-plane orientation direction of the liquid crystal molecules in the liquid crystal layer is approximately 0° or the in-plane orientation direction of the liquid crystal molecules in the liquid crystal layer is approximately 90°.

15. A display device, comprising a display panel according to claim 11.
